(19) United States
(12) Patent Application Publication
(10) Pub. No.: US 2020/0284485 A1
(43) Pub. Date: Sep. 10, 2020

(54) EXPANSION VALVE

(71) Applicant: FUJIKOKI CORPORATION, Tokyo (JP)

(72) Inventors: Junya HAYAKAWA, Tokyo (JP); Ryo MATSUDA, Tokyo (JP)

(21) Appl. No.: 16/649,275

(22) PCT Filed: Sep. 13, 2018
(86) PCT No.: PCT/JP2018/033999

§ 371 Date: Mar. 20, 2020

(30) Foreign Application Priority Data
Sep. 25, 2017 (JP) 2017-183170

(51) Int. Cl. F25B 41/06; F25B 13/00

(52) U.S. Cl. CPC F25B 41/062; F16K 47/02; F25B 13/00

(57) ABSTRACT

The present invention provides an expansion valve which is compact and can further enhance muffling performance. The expansion valve includes a valve main body including an inlet passage configured to introduce a high-pressure refrigerant, a valve chamber configured to communicate with the inlet passage, an expansion chamber that includes an orifice configured to reduce a pressure of the refrigerant introduced into the valve chamber, and an outlet passage disposed downstream of the expansion chamber and configured to discharge the refrigerant that passes through the expansion chamber, a rectifier disposed in the valve main body and configured to partition the expansion chamber and the outlet passage, a valve member configured to open and close the orifice, and a valve member driving device configured to drive the valve member. The rectifier includes a hollow convex portion projecting toward the outlet passage and a throttle hole formed at a distal end of the hollow convex portion, and the refrigerant that enters the expansion chamber when the orifice opens passes through the throttle hole and travels toward the evaporator.

### TECHNICAL FIELD

The present invention relates to an expansion valve for use in refrigeration cycles.

### BACKGROUND OF THE INVENTION

In general vehicles, in order to provide a comfortable interior environment with less noise, noise reduction during the operation of car air conditioners, for instance, is required. There are various causes of the noise generated by the operation of car air conditioners, but the expansion valve used for refrigeration cycles is sometimes noted as a noise generation source. In this type of expansion valve, the high-pressure refrigerant emits a characteristic operation sound when the high-pressure refrigerant is decompressed by the orifice and travels to the evaporator, and particularly in cases in which the expansion valve is installed on the partition wall that separates the engine compartment from the vehicle compartment, this operation sound is easily transmitted to the inside of the vehicle, such that there is demand for noise reduction. In order to reduce such noise, various proposals have been made regarding expansion valves.

Patent Document 1 discloses an expansion valve in which a rectifier with a throttle opening is provided in the outlet passage leading toward the evaporator. According to such an expansion valve, when passing through the throttle opening, the air bubbles in the refrigerant are subdivided, thereby reducing the noise caused by the rupturing of these air bubbles.

### CITATION LIST

### Patent Literature

[Patent Document 1] Japanese Laid-Open Patent Application No. 2013-231571

### SUMMARY OF INVENTION

### Technical Problem

In addition to the noise caused by the rupture of air bubbles, noise caused by turbulent flow of the refrigerant may occur, but by providing the rectifier, such noise can also be reduced. More specifically, the refrigerant throttled by the orifice of the expansion valve expands until the refrigerant reaches the outlet passage, and then the traveling direction of the refrigerant changes by approximately 90 degrees, which may invite the risk of turbulent flow which causes noise. Therefore, by throttling the expanded refrigerant once again with the rectifier throttle opening, it is possible to prevent the generation of turbulence and to achieve noise reduction. This is referred to as what is known as a “muffler effect”.

Incidentally, in order to exhibit a sufficient muffling effect, it is desirable to enlarge the volume of the space through which the refrigerant passes from the orifice to the rectifier as much as possible. On the other hand, in car air conditioners and the like, the miniaturization of components is prioritized, and it is desirable to miniaturize the expansion valve as much as possible. However, if the expansion valve is miniaturized, the volume of the space from the orifice to the rectifier is also restricted, and there is a risk that the muffler effect cannot be sufficiently exhibited.

It is an object of the present disclosure to provide an expansion valve which is compact and can further enhance muffling performance.

### Solution to Problem

In order to achieve the above object, the expansion valve according to the present invention includes a valve main body including an inlet passage configured to introduce a high-pressure refrigerant, a valve chamber configured to communicate with the inlet passage, an expansion chamber that includes an orifice configured to reduce a pressure of the refrigerant introduced into the valve chamber, and an outlet passage disposed downstream of the expansion chamber and configured to discharge the refrigerant that passes through the expansion chamber, a rectifier disposed in the valve main body and configured to partition the expansion chamber and the outlet passage, a valve member configured to open and close the orifice, and a valve member driving device configured to drive the valve member, wherein the rectifier includes a hollow convex portion projecting toward the outlet passage and a throttle hole formed at a distal end of the hollow convex portion.

Preferably, the hollow convex portion is cylindrical, and has an outer diameter less than an inner diameter of a pipe connected to the outlet passage.

Preferably, at least a portion of the hollow convex portion is disposed inside the pipe.

The rectifier is preferably formed by press forming a metallic plate.

### Advantageous Effects of Invention

According to the present disclosure, it is possible to provide an expansion valve which is compact and can further enhance muffling performance.

### BRIEF DESCRIPTION OF DRAWINGS

FIG. 1 is a diagram that schematically illustrates the entire configuration of an expansion valve according to the present embodiment.

FIG. 2 is an enlarged view of an area AR around the orifice.

FIG. 3 is a perspective view of the rectifier.

FIG. 4 is a schematic cross-sectional view that schematically illustrates the application of the expansion valve to a refrigerant circulation system according to the present embodiment.

### DESCRIPTION OF EMBODIMENT(S)

Referring now to the drawings, an expansion valve 1 according to an embodiment of the present disclosure will be described. It should be noted that in the following description of the embodiments and comparative examples, parts and members having the same functions are denoted by the same reference numerals, and redundant description of parts and members denoted by the same reference numerals is omitted.

### (Definition of Directions)

In this specification, the direction from the valve body 3 to the actuation rod 5 is defined as the “upward direction” and the direction from the actuation rod 5 to the valve body 3 is defined as the “downward direction” on the paper surface of the drawings.

### (Overview of Expansion Valve)

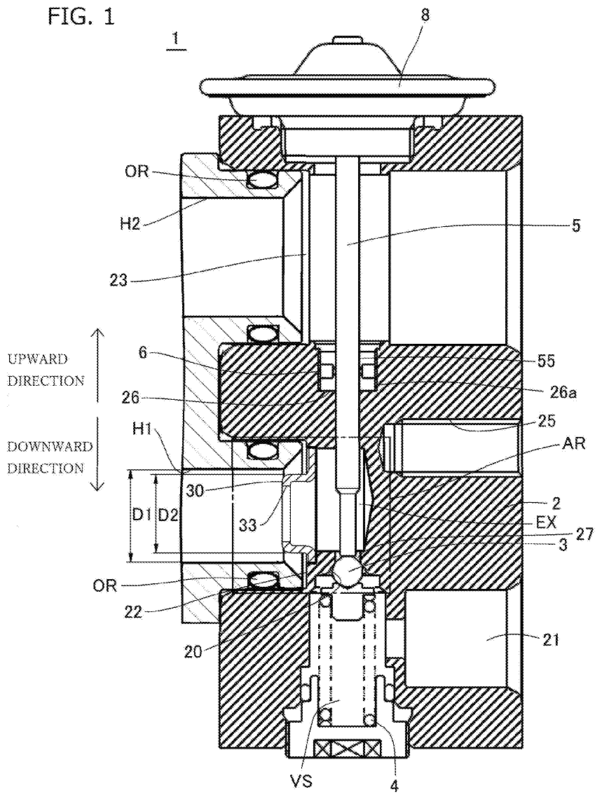

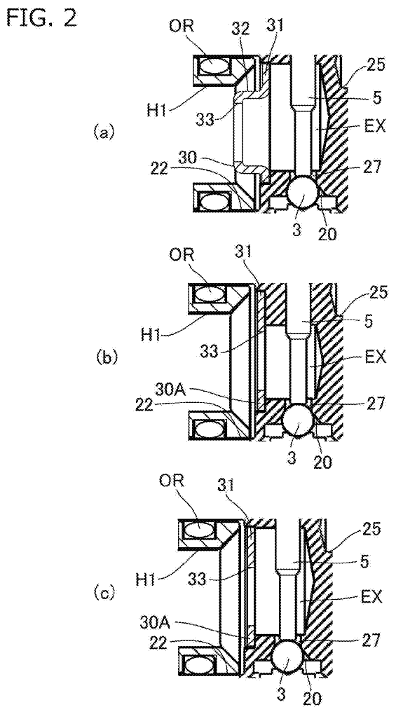

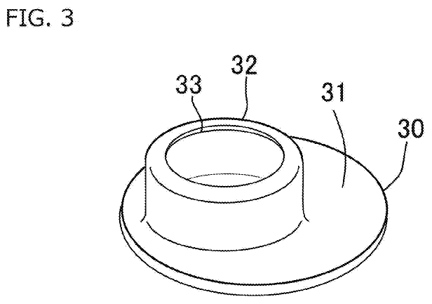

An overview of the expansion valve 1 in the present embodiment will be described with reference to FIG. 1 to FIG. 3. FIG. 1 is a diagram that schematically illustrates the entire configuration of an expansion valve 1 according to the present embodiment together with a pipe connected to an evaporator. It should be noted that, in FIG. 1, the portion corresponding to the power element 8 is illustrated in a side view, and the remaining portions are illustrated in a cross-sectional view. FIG. 2 is an enlarged view of an area AR around the orifice, where (a) is an enlarged view of the present embodiment, and (b) and (c) are enlarged views of the same portion in the comparative examples. FIG. 3 is a perspective view of the rectifier.

The expansion valve 1 comprises an aluminum valve main body 2 with a valve chamber VS, a valve body 3, a biasing member 4, an actuation rod 5, and a ring spring 6.

In addition to the valve chamber VS, the valve main body 2 includes a first flow path 21 and a second flow path 22. The first flow path 21 is, for example, a supply-side flow path (also referred to as an inlet flow path), and the valve chamber VS is supplied with fluids through the supply-side flow path. The second flow path 22 is, for example, a discharge-side flow path (also referred to as an outlet flow path), and the fluid in the valve chamber VS is discharged out of the expansion valve through the discharge-side flow path. Connected to the second flow path 22 is a pipe H1 which extends to and is connected to an evaporator (not illustrated in FIG. 1). On the outer periphery of the end of the pipe H1, an O-ring OR is arranged so as to abut against the inner wall of the second flow path 22, thereby preventing leakage of the refrigerant.

A rectifier 30 is disposed near the entrance of the second flow path 22 of the valve main body 2 so as to enter the pipe H1. As illustrated in FIG. 3, the rectifier 30 has a substantially top hat shape, and specifically, has a circular sheet portion 31 and a hollow cylindrically shaped hollow convex portion 32 integrally provided with the circular sheet portion 31, and an opening (also referred to as a throttle hole) 33 formed at the distal end of the hollow convex portion 32. It should be noted that the circular sheet portion 31 and the hollow convex portion 32 are eccentric to each other, but may be coaxial.

In the present embodiment, the rectifier 30 is formed by press-forming a plate material such as SUS, but the rectifier 30 may be formed of a resin. Alternatively, the circular sheet portion 31 and the hollow convex portion 32 may be separate bodies, which form the rectifier when joined together. The outer periphery of the circular sheet portion 31 is attached to the inner wall of the second flow path 22 by a method such as caulking or press-fitting.

In FIG. 1, when the outer diameter of the hollow convex portion 32 is defined as D2 and the inner diameter of the pipe H1 is defined as D1, the relationship D2 D1 is satisfied. Accordingly, as illustrated in FIG. 1, the rectifier 30 can be assembled by causing the hollow convex portion 32 to enter into the interior of the pipe H1. However, in consideration of the assembly error with the pipe H1, it is more desirable to set a relationship of D2<D1 to ensure smooth assembly.

The valve body 3 is located in valve chamber VS. When the valve body 3 is seated on the valve seat 20 of the valve main body 2, the first flow path 21 and the second flow path 22 are not in communication with each other. On the other hand, when the valve body 3 is separated from the valve seat 20, the first flow path 21 and the second flow path 22 are in communication.

The biasing member 4 biases the valve body 3 towards the valve seat 20. The biasing member 4 is, for example, a coiled spring.

The lower end of the actuation rod 5 contacts the valve body 3. In addition, the actuation rod 5 can press the valve body 3 in the opening direction against the biasing force of the biasing member 4. When the actuation rod 5 moves downwards, the valve body 3 is separated from the valve seat 20 and the expansion valve 1 is opened.

The space from the small diameter orifice 27 located downstream of the valve seat 20 to the opening 33 of the rectifier 30 is referred to as expansion chamber EX. That is, the rectifier 30 partitions the expansion chamber EX and the second flow path 22. A bolt hole 25 used for fastening to another member is formed by interposing thin walls with respect to the expansion chamber EX.

The ring spring 6 is a vibration isolating member for suppressing the vibration of the actuation rod 5. The ring spring 6 is disposed between the outer peripheral surface 55 of the actuation rod 5 and the inner peripheral surface 26a of the valve main body 2. However, the ring spring 6 is not necessarily required.

A return flow path (also known as a return passage) 23 is formed in the upper portion of the valve main body 2. Connected to the return flow path 23 is a pipe H2 that extends from the evaporator (not illustrated in FIG. 1). On the outer periphery of the end of the pipe H2, an O-ring OR is arranged so as to abut against the inner wall of the return flow path 23, thereby preventing leakage of the refrigerant.

Next, the effect of the present embodiment will be described via comparison with a comparative example. First, in Comparative Example 1 illustrated in FIG. 2(b), the rectifier 30A is composed of only the circular sheet portion 31, and the circular sheet portion 31 has an opening 33. The opening 33 is made to have the same shape as the opening 33 of the rectifier 30. In addition, the volume of the expansion chamber EX is relatively small compared to the present embodiment.

Also, in Comparative Example 1 as illustrated in FIG. 2(b), using the so-called muffler effect, it is possible to reduce, to some extent, the passage noise emitted by the refrigerant after passing between the valve seat 20 and the valve body 3 and the orifice 27 at the time of valve opening.

On the other hand, as illustrated in Comparative Example 2 as illustrated in FIG. 2(c), even if the same rectifier 30A is used, the so-called muffler effect is enhanced by increasing the volume of the expansion chamber EX, and a larger passage noise reduction effect can be expected. However, when the bolt hole 25 is provided in the valve main body 2, for example, the volume of the expansion chamber EX is limited to avoid interference, and it is difficult to obtain a further reduction in passage noise.

Therefore, in the present embodiment, by using a rectifier 30 having the hollow convex portion 32 as illustrated in FIG. 2(a), the volume of the expansion chamber EX including the orifice can be further enlarged, and the so-called muffler effect can be further enhanced, so that a greater passage noise reduction effect can be expected. In particular, by inserting a portion of the hollow convex portion 32 into the pipe H1, it is possible to suppress interference with the pipe H1, and to maintain a compact outer shape of the valve main body 2 while increasing the volume of the expansion chamber EX. Such effects are of particular importance in the expansion valves used for car air conditioners and the like. It should be noted that the diameter and length of the hollow convex portion 32, the area and the shape of the opening 33, and the like can be selected to be optimal according to the specifications of the products. In addition, the diameter of the holes of the expansion chamber EX (the diameter perpendicular to the central axes of the hollow convex portion 32) is not limited to the size illustrated in FIG. 2(a), and can be any diameter.

### (Application Example of Expansion Valve 1)

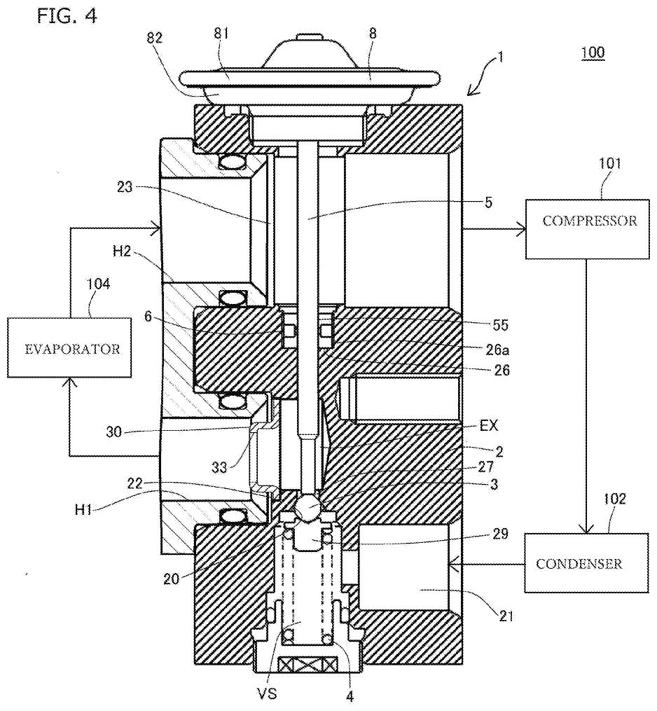

An application example of the expansion valve 1 will be described with reference to FIG. 4. FIG. 4 is a schematic cross-sectional view that schematically illustrates an example in which the expansion valve 1 in the above-described embodiment is applied to a refrigerant circulation system 100.

In the embodiment illustrated in FIG. 4, the expansion valve 1 is fluidly connected to a compressor 101, a condenser 102, and an evaporator 104.

In addition, the expansion valve 1 includes a power element 8 and a return flow path 23 in addition to the valve main body 2, the valve body 3, the biasing member 4, the actuation rod 5, the ring spring 6, the first flow path 21 and the second flow path 22. The valve body 3 and the valve seat 20 constitute a valve member, and the power element 8, the biasing member 4 and the actuation rod 5 constitute a valve member driving device.

Referring to FIG. 4, the refrigerant pressurized by the compressor 101 is liquefied by the condenser 102, and sent to the expansion valve 1. In addition, the refrigerant adiabatically expanded in the expansion valve 1 is delivered to the evaporator 104 through the pipe H1, and heat exchanged in the evaporator 104 with the air flowing around the evaporator. The refrigerant returning from the evaporator 104 is returned from the pipe H2 to the compressor 101 through the expansion valve 1 (more specifically, the return flow path 23).

Expansion valve 1 is supplied with high-pressure refrigerant from the condenser 102. More specifically, the high pressure refrigerant from the condenser 102 is supplied to the valve chamber VS via the first flow path 21. In the valve chamber VS, the valve body 3 is disposed opposite the valve seat 20. The valve body 3 is supported by a valve body support 29, and the valve body support 29 is biased upwardly by the biasing member 4, (for example, a coiled spring). In other words, the valve body 3 is biased by the biasing member 4 toward the valve closing direction. The biasing member 4 is disposed between the valve body support 29 and the biasing member receiving member 24. In the embodiment illustrated in FIG. 4, the biasing member receiving member 24 is a plug that is mounted on the valve main body 2 to seal the valve chamber VS.

When the valve body 3 is seated on the valve seat 20 (in other words, when the expansion valve 1 is in the closed state), the first flow path 21 on the upstream side of the valve chamber VS and the second flow path 22 on the downstream side of the valve chamber VS are not in communication with each other. On the other hand, when the valve body 3 is separated from the valve seat 20 (in other words, when the expansion valve 1 is in an open state), the refrigerant supplied to the valve chamber VS is delivered to the evaporator 104 through the second flow path 22. At this time, by entering the expansion chamber EX having a large volume after passing through the orifice 27 and then passing through the opening 33 of the rectifier 30, the passage noise is effectively reduced. The switching between the closed state and the open state of the expansion valve 1 is carried out by the actuation rod 5 connected to the power element 8.

In the embodiment illustrated in FIG. 4, the power element 8 is disposed at the upper end of the expansion valve 1. The power element 8 includes an upper lid member 81, a receiving member 82 that has an opening at its center, and a diaphragm (not illustrated in the figures) disposed between the upper lid member 81 and the receiving member 82. The first space surrounded by the upper lid member 81 and the diaphragm is filled with a working gas.

The lower surface of the diaphragm is connected to the actuation rod via a diaphragm support member. Therefore, when the working gas in the first space is liquefied, the actuation rod 5 moves upward, and when the liquefied working gas is vaporized, the actuation rod 5 moves downward. In this way, the switching between the open state and the closed state of the expansion valve 1 is carried out.

The second space between the diaphragm and the receiving member 82 is in communication with the return flow path 23. Therefore, the phase (gas phase, liquid phase, or the like) of the working gas in the first space changes in accordance with the temperature and pressure of the refrigerant flowing through the return flow path 23, and the actuation rod 5 is driven. In other words, in the expansion valve 1 illustrated in FIG. 4, the quantity of the refrigerant supplied from the expansion valve 1 to the evaporator 104 is automatically adjusted in accordance with the temperature and pressure of the refrigerant returning from the evaporator 104 to the expansion valve 1. In the embodiment illustrated in FIG. 4, the return flow path 23 communicates with the concave portion 26, and the concave portion 26 is disposed below the return flow path 23.

It should be noted that the present invention is not limited to the above-mentioned embodiments. Variations of any of the components of the embodiments described above are possible within the scope of the present invention. In addition, any component can be added or omitted in the above-described embodiment.

For example, instead of the hollow cylindrical shape, the hollow convex portion of the rectifier 30 may have a hollow tapered shape (a hollow frusto-conical shape) or a hollow square cylindrical shape.

### REFERENCE SIGNS LIST

1: expansion valve
2: valve main body
3: valve body
4: biasing member
5: actuation rod
6: ring spring
8: power element
20: valve seat
21: first flow path
22: second flow path
23: return flow path
24: biasing member receiving member
25: bolt hole
26: concave portion
27: orifice
30: rectifier
31: circular sheet portion
32: hollow convex portion
33: opening
100: refrigerant circulation system
101: compressor
102: condenser
104: evaporator
EX: expansion chamber
H1, H2: pipe
VS: valve chamber

1. An expansion valve comprising:
a valve main body including:
an inlet passage configured to introduce a high-pressure refrigerant,
a valve chamber configured to communicate with the inlet passage,
an expansion chamber that includes an orifice configured to reduce a pressure of the refrigerant introduced into the valve chamber, and
an outlet passage disposed downstream of the expansion chamber and configured to discharge the refrigerant that passes through the expansion chamber;
a rectifier disposed in the valve main body and configured to partition the expansion chamber and the outlet passage;
a valve member configured to open and close the orifice; and
a valve member driving device configured to drive the valve member;
wherein the rectifier includes a hollow convex portion projecting toward the outlet passage and a throttle hole formed at a distal end of the hollow convex portion.

2. The expansion valve according to claim 1, wherein:
the hollow convex portion is cylindrical, and has an outer diameter smaller than an inner diameter of a pipe connected to the outlet passage.

3. The expansion valve according to claim 2, wherein:
at least a portion of the hollow convex portion is disposed inside the pipe.

4. The expansion valve according to claim 1, wherein:
the rectifier is formed by press forming a metallic plate.
